(19) United States
(12) Patent Application Publication
(10) Pub. No.: US 2008/0009422 A1
(43) Pub. Date: Jan. 10, 2008

(54) HIGH PERFORMANCE WATER BASE DRILLING FLUID

(75) Inventors: Arvind D. Patel, Sugar Land, TX (US); Emanuel Stamatakis, Houston, TX (US); Steve Young, Cypress, TX (US); Jim Friedheim, Spring, TX (US)

Correspondence Address: OSHA LIANG/MI, ONE HOUSTON CENTER, SUITE 2800, HOUSTON, TX, 77010, US

(73) Assignee: M-I LLC, Houston, TX (US)

(21) Appl. No.: 11/772,618

(22) Filed: Jul. 2, 2007

Related U.S. Application Data
(60) Provisional application No. 60/806,747, filed on Jul. 7, 2006.

(51) Int. Cl. C09K 8/18

(52) U.S. Cl. 507/110; 507/116

(57) ABSTRACT

A water based drilling fluid which includes an aqueous fluid, at least one of a weighting agent and a gelling agent, and a lubricant, which includes at least one ester derivative of at least one fatty acid derived from castor oil is disclosed.

### CROSS-REFERENCE TO RELATED APPLICATIONS

This application, pursuant to 35 U.S.C. §119, claims priority to U.S. Patent Application Ser. No. 60/806,747, filed Jul. 7, 2006, which is herein incorporated by reference in its entirety.

### BACKGROUND OF INVENTION

1. Field of the Invention

Embodiments disclosed herein relate generally to components of wellbore fluids (muds). In particular, embodiments relate to water-based muds and components thereof.

2. Background Art

When drilling or completing wells in earth formations, various fluids typically are used in the well for a variety of reasons. Common uses for well fluids include: lubrication and cooling of drill bit cutting surfaces while drilling generally or drilling-in (i.e., drilling in a targeted petroliferous formation), transportation of “cuttings” (pieces of formation dislodged by the cutting action of the teeth on a drill bit) to the surface, controlling formation fluid pressure to prevent blowouts, maintaining well stability, suspending solids in the well, minimizing fluid loss into and stabilizing the formation through which the well is being drilled, fracturing the formation in the vicinity of the well, displacing the fluid within the well with another fluid, cleaning the well, testing the well, transmitting hydraulic horsepower to the drill bit, fluid used for emplacing a packer, abandoning the well or preparing the well for abandonment, and otherwise treating the well or the formation.

In most rotary drilling procedures the drilling fluid takes the form of a “mud,” i.e., a liquid having solids suspended therein. The solids function to impart desired rheological properties to the drilling fluid and also to increase the density thereof in order to provide a suitable hydrostatic pressure at the bottom of the well.

Drilling fluids are generally characterized as thixotropic fluid systems. That is, they exhibit low viscosity when sheared, such as when in circulation (as occurs during pumping or contact with the moving drilling bit). However, when the shearing action is halted, the fluid should be capable of suspending the solids it contains to prevent gravity separation. In addition, when the drilling fluid is under shear conditions and a free-flowing near-liquid, it must retain a sufficiently high enough viscosity to carry all unwanted particulate matter from the bottom of the well bore to the surface. The drilling fluid formulation should also allow the cuttings and other unwanted particulate material to be removed or otherwise settle out from the liquid fraction.

There is an increasing need for drilling fluids having the rheological profiles that enable wells to be drilled more easily. Drilling fluids having tailored Theological properties ensure that cuttings are removed from the wellbore as efficiently and effectively as possible to avoid the formation of cuttings beds in the well which can cause the drill string to become stuck, among other issues. There is also the need from a drilling fluid hydraulics perspective (equivalent circulating density) to reduce the pressures required to circulate the fluid, reducing the exposure of the formation to excessive forces that can fracture the formation causing the fluid, and possibly the well, to be lost. In addition, an enhanced profile is necessary to prevent settlement or sag of the weighting agent in the fluid, if this occurs it can lead to an uneven density profile within the circulating fluid system which can result in well control (gas/fluid influx) and wellbore stability problems (caving/fractures).

To obtain the fluid characteristics required to meet these challenges the fluid must be easy to pump, so it requires the minimum amount of pressure to force it through restrictions in the circulating fluid system, such as bit nozzles or down-hole tools. In other words the fluid must have the lowest possible viscosity under high shear conditions. Conversely, in zones of the well where the area for fluid flow is large and the velocity of the fluid is slow or where there are low shear conditions, the viscosity of the fluid needs to be as high as possible in order to suspend and transport the drilled cuttings. This also applies to the periods when the fluid is left static in the hole, where both cuttings and weighting materials need to be kept suspended to prevent settlement. However, it should also be noted that the viscosity of the fluid should not continue to increase under static conditions to unacceptable levels. Otherwise when the fluid needs to be circulated again this can lead to excessive pressures that can fracture the formation or lead to lost time if the force required to regain a fully circulating fluid system is beyond the limits of the pumps.

Drilling fluids are typically classified according to their base material. The drilling mud may be either a water-based mud having solid particles suspended therein or an oil-based mud with water or brine emulsified in the oil to form a discontinuous phase and solid particules suspended in the oil continuous phase.

On both offshore and inland drilling barges and rigs, drill cuttings are conveyed up the hole by the drilling fluid. Water-based drilling fluids may be suitable for drilling in certain types of formations; however, for proper drilling in other formations, it is desirable to use an oil-based drilling fluid. With an oil-based drilling fluid, the cuttings, besides ordinarily containing moisture, are coated with an adherent film or layer of oily drilling fluid which may penetrate into the interior of each cutting. This is true despite the use of various vibrating screens, mechanical separation devices, and various chemical and washing techniques. Because of pollution to the environment, whether on water or on land, the cuttings cannot be properly discarded until the pollutants have been removed.

Thus, historically, the majority of oil and gas exploration has been performed with water-based muds. The primary reason for this preference is price and environmental compatibility. The used mud and cuttings from wells drilled with water-based muds can be readily disposed of onsite at most onshore locations and discharged from platforms in many U.S. offshore waters, as long as they meet current effluent limitations guidelines, discharge standards, and other permit limits. As described above, traditional oil-based muds made from diesel or mineral oils, while being substantially more expensive than water-based drilling fluids, are environmentally hazardous.

As a result, the use of oil-based muds has been limited to those situations where they are necessary. The selection of an oil-based well bore fluid involves a careful balance of both the good and bad characteristics of such fluids in a particular application. An especially beneficial property of oil-based muds is their excellent lubrication qualities. These lubrication properties permit the drilling of wells having a significant vertical deviation, as is typical of off-shore or deep water drilling operations or when a horizontal well is desired. In such highly deviated holes, torque and drag on the drill string are a significant problem because the drill pipe lies against the low side of the hole, and the risk of pipe sticking is high when water-based muds are used. In contrast oil-based muds provide a thin, slick filter cake which helps to prevent pipe sticking.

Oil-based muds typically have excellent lubricity properties in comparison to water based muds, which reduces sticking of the drillpipe due to a reduction in frictional drag. The lubricating characteristics (lubricity) of the drilling mud provides the only known means for reducing the friction. Additionally, the use of oil-based muds is also common in high temperature wells because oil muds generally exhibit desirable Theological properties over a wider range of temperatures than water-based muds.

Thus components or additives imparting a lubricating effect on water-based muds are desirable. Previously used lubricating materials include, for example, mineral oils, animal and vegetable oils and esters. However, the increasingly stricter regulations with regard to the biodegradability of drilling fluids and their constituents are gradually restricting the use of the otherwise particularly suitable mineral oils. Thus, there is a growing interest in alternatives having better biodegradability, such as esters, in particular. EP 0 770 661, for example, describes esters of monocarboxylic acids with monohydric alcohols as suitable lubricants for water-based drilling fluid systems However, only a 2-ethylhexyl oleate is mentioned as a lubricant suitable for silicate-containing aqueous fluids. However, the use of many known carboxylic acid esters in water-based systems often leads to considerable difficulties. For example, ester cleavage of the ester additives frequently results in the formation of components with a marked tendency to foam, which then introduces undesirable side effects into the fluid systems. Similarly, sulfonates of vegetable oils, in particular soya oil sulfonate, which have also been used as lubricants in water- and oil-based systems, show significant foaming, especially in water-based fluids, which restricts their usefulness.

Accordingly, there exists a continuing need for water-based fluids having improved properties including lubricity.

### SUMMARY OF INVENTION

In one aspect, embodiments disclosed herein relate to a water based drilling fluid, which includes an aqueous fluid, at least one of a weighting agent and a gelling agent, and a lubricant including at least one ester derivative of at least one fatty acid derived from castor oil.

In another aspect, embodiments disclosed herein relate to a method of treating a wellbore, which includes mixing an aqueous fluid, at least one of a weighting agent and a gelling agent, and a lubricant including at least one ester derivative of at least one fatty acid derived from castor oil to form a water based wellbore fluid, and using this water based wellbore fluid during a drilling operation.

In yet another embodiment disclosed herein relate to a wellbore fluid which includes an aqueous fluid, at least one of a weighting agent and a gelling agent; and a lubricant which includes at least one ester derivative of ricinoleic acid and at least one of sorbitan and pentaerythitrol.

Other aspects and advantages of the invention will be apparent from the following description and the appended claims.

### DETAILED DESCRIPTION

Embodiments disclosed herein relate to lubricants for use in water-based wellbore fluid formulations. In particular, embodiments described herein relate to lubricants comprising ester derivatives of fatty acids found in castor oil. In the following description, numerous details are set forth to provide an understanding of the present disclosure. However, it will be understood by those skilled in the art that the present disclosure may be practiced without these details and that numerous variations or modifications from the described embodiments may be possible.

In one embodiment, a water-based drilling fluid comprises an aqueous fluid, a lubricant and at least one of a weighting agent and a gelling agent. The lubricant may comprise at least one ester derivative of at least one fatty acid derived from castor oil. In another embodiment, a wellbore fluid may comprise an aqueous fluid, a lubricant, and at least one of a weighting agent and a gelling agent, wherein the lubricant may comprise at least one ricinoleic acid ester derivative. One of ordinary skill in the art would recognize that drilling or wellbore fluids may also comprise various other additives.

Castor Oil-Based Lubricant

In one embodiment, a lubricant may be formed by reaction of at least one fatty acid derived from castor oil with at least one mono-, di-, tri-, or polyol to form an ester derivative. Such fatty acids naturally occurring in castor oil may include at least one of ricinoleic acid, oleic acid, stearic acid, palmitic acid, dihydroxystearic acid, linoleic acid, linolenic acid, and eicosanoic acid.

The principal component of castor oil is ricinoleic acid which has a relatively constant abundance of about 89.5%. Castor oil is the only natural source of the 18 carbon monounsaturated hydroxylated fatty acid, ricinoleic acid. Both the hydroxyl group and the olefin of ricinoleic acid may allow for further chemical functionalization and refinement of physical properties. Additionally, ester derivatives of ricinoleic acid, as well as other fatty acids occurring in castor oil, may be non-toxic and readily biodegradable. The long chain fatty acids may also provide derivatives that have desirable viscosity/rheological profiles. For example, the pentaerythritol tetraester with ricinoleic acid has a viscosity index (VI) of 155.

In one embodiment, castor oil, and thus the mixture of fatty acids naturally occuring in castor oil, is subjected directly to esterification with at least one mono-, di-, tri-, or polyol to form a mixture of fatty acid ester derivatives. In another embodiment, any combination of fatty acids including ricinoleic acid, oleic acid, stearic acid, palmitic acid, dihydroxystearic acid, linoleic acid, linolenic acid, or eicosanoic acid may be esterifed with at least one mono-, di-, tri-, or polyol. In yet another embodiment, ricinoleic acid may be reacted with at least one mono-, di-, tri-, or polyol.

In one embodiment, at least one fatty acid ester derived from castor oil may be reacted with at least one mono-, di-, tri-, or polyol. In a particular embodiment, the polyol may comprise at least one of sorbitane, pentaerythritol, polyglycol, glycerol, neopentyl glycol, trimethanolpropane, di- and/or tripentaerythritol, and the like. In another embodiment, the ester derivative may be formed by reaction with at least one of sorbitane or pentaerythritol. The reaction of at least one fatty acid with at least one mono-, di- tri-, or polyol may be conducted in a manner known by those skilled in the art. Such reactions may include, but are not limited to, Fischer (acid-catalyzed) esterification and acid-catalyzed transesterification, for example.

In one embodiment, the mole ratio of fatty acid to alcohol component may range from about 1:1 to about 5:1. In another embodiment, the ratio may be about 2:1 to about 4:1. More specifically, this mole ratio relates the reactive mole equivalent of available hydroxyl groups with the mole equivalent of carboxylic acid functional groups of the fatty acid. In one embodiment, the mole ratio of carboxylic acid of the at least one fatty acid from castor oil to the hydroxyl groups of the at least one of sorbitane or pentaerythritol may range from about 1:1 to about 5:1, and from about 2:1 and about 4:1, in another embodiment.

Drilling/Wellbore Fluid Formulation

In one embodiment, a water based drilling fluid comprises an aqueous fluid, a lubricant derived from castor oil or its components as described above, and at least one of a weighting agent and a gelling agent.

The aqueous fluid of the wellbore fluid may include at least one of fresh water, sea water, brine, mixtures of water and water-soluble organic compounds and mixtures thereof. For example, the aqueous fluid may be formulated with mixtures of desired salts in fresh water. Such salts may include, but are not limited to alkali metal chlorides, hydroxides, or carboxylates, for example. In various embodiments of the drilling fluid disclosed herein, the brine may include seawater, aqueous solutions wherein the salt concentration is less than that of sea water, or aqueous solutions wherein the salt concentration is greater than that of sea water. Salts that may be found in seawater include, but are not limited to, sodium, calcium, aluminum, magnesium, potassium, strontium, and lithium, salts of chlorides, bromides, carbonates, iodides, chlorates, bromates, formates, nitrates, oxides, phosphates, sulfates, silicates, and fluorides. Salts that may be incorporated in a given brine include any one or more of those present in natural seawater or any other organic or inorganic dissolved salts. Additionally, brines that may be used in the drilling fluids disclosed herein may be natural or synthetic, with synthetic brines tending to be much simpler in constitution. In one embodiment, the density of the drilling fluid may be controlled by increasing the salt concentration in the brine (up to saturation). In a particular embodiment, a brine may include halide or carboxylate salts of mono- or divalent cations of metals, such as cesium, potassium, calcium, zinc, and/or sodium.

In one embodiment, the water-based drilling fluid may include a weighting agent. Weighting agents or density materials suitable for use the fluids disclosed herein include galena, hematite, magnetite, iron oxides, illmenite, barite, siderite, celestite, dolomite, calcite, and the like. The quantity of such material added, if any, may depend upon the desired density of the final composition. Typically, weighting agent is added to result in a drilling fluid density of up to about 24 pounds per gallon. The weighting agent may be added up to 21 pounds per gallon in one embodiment, and up to 19.5 pounds per gallon in another embodiment.

In another embodiment, the water-based drilling fluid may include a gelling agent. The gelling agents suitable for use in the fluids disclosed herein may include, for example, high molecular weight polymers such as partially hydrolyzed polyacrylamide (PHPA), biopolymers, bentonite, attapulgite, and sepiolite. Examples of biopolymers include guar gum, starch, xanthan gum and the like. Such materials are frequently used as fluid loss materials and to maintain wellbore stability.

Other additives that may be included in the wellbore fluids disclosed herein include for example, wetting agents, organophilic clays, viscosifiers, fluid loss control agents, surfactants, shale inhibitors, filtration reducers, dispersants, interfacial tension reducers, pH buffers, mutual solvents, thinners (such as lignins and tannins), thinning agents and cleaning agents. The addition of such agents should be well known to one of ordinary skill in the art of formulating drilling fluids and muds.

Viscosifiers, such as water soluble polymers and polyamide resins, may also be used. The amount of viscosifier used in the composition can vary upon the end use of the composition. However, normally about 0.1% to 6% by weight range is sufficient for most applications. Other viscosifiers include DUOVIS® and BIOVIS® manufactured and distributed by M-I L.L.C. In some embodiments, the viscosity of the displacement fluids is sufficiently high such that the displacement fluid may act as its own displacement pill in a well.

A variety of fluid loss control agents may be added to the drilling fluids disclosed herein that are generally selected from a group consisting of synthetic organic polymers, biopolymers, and mixtures thereof Fluid loss control agents such as modified lignite, polymers, modified starches and modified celluloses may also be added to the water-based drilling fluid system of this invention. In one embodiment, these additives should be selected to have low toxicity and to be compatible with common anionic drilling fluid additives such as polyanionic carboxymethylcellulose (PAC or CMC), polyacrylates, partially-hydrolyzed polyacrylamides (PHPA), lignosulfonates, xanthan gum, mixtures of these and the like. Fluid loss control agents may include, for example, POLYPAC® UL polyanionic cellulose (PAC) which is available from M-I L.L.C. (Houston, Tex.), a water-soluble polymer which causes a minimal increase in viscosity in water-base muds.

Thinners may be added to the drilling fluid in order to reduce flow resistance and gel development in various embodiments disclosed herein. Typically, lignosulfonates, lignitic materials, modified lignosulfonates, polyphosphates and tannins are added. In other embodiments low molecular weight polyacrylates can also be added as thinners. Other functions performed by thinners include the reduction of filtration and cake thickness, to counteract the effects of salts, to minimize the effects of water on the formations drilled, to emulsify oil in water, and to stabilize mud properties at elevated temperatures. TACKLE® (manufactured and commercially available from M-I L.L.C.) liquid polymer is a low- molecular- weight, anionic thinner that may be used to deflocculate a wide range of water-based drilling fluids.

Shale inhibition is achieved by preventing water uptake by clays, and by providing superior cuttings integrity. Shale inhibitor additives effectively inhibits shale or gumbo clays from hydrating and minimizes the potential for bit balling. Shale inhibitors may include ULTRAHIB™ (manufactured and distributed by M-I L.L.C.) which is a liquid polyamine. Other important additives may include ULTRACAP™, an acrylamide copolymer important for cutting encapsulation and inhibiting clay dispersion. The shale inhibitor may be added directly to the mud system with no effect on viscosity or filtration properties. Many shale inhibitors serve the dual role as filtration reducers as well. Examples may include, but are not limited to ACTIGUARD™ ASPHASOL, and CAL-CAP™ all manufactured and distributed by M-I L.L.C. Other filtration reducers may include polysaccharide-based UNITROL™, manufactured and distributed by M-I L.L.C.

In one embodiment, a method of treating a well bore comprises mixing an aqueous fluid comprising at least one of a weighting agent and a gelling agent, and a lubricant. The lubricant comprising at least one ester derivative of at least one fatty acid derived from castor oil to form a water-based wellbore fluid. The water-based wellbore fluid may then be used during a drilling operation. The fluid may be pumped down to the bottom of the well through a drill pipe, where the fluid emerges through ports in the drilling bit, for example. In one embodiment, the fluid may be used in conjunction with any drilling operation, which may include, for example, vertical drilling, extended reach drilling, and directional drilling. One skilled in the art would recognize that water-based drilling muds may be prepared with a large variety of formulations. Specific formulations may depend on the state of drilling a well at a particular time, for example, depending on the depth and/or the composition of the formation. The drilling mud compositions described above may be adapted to provide improved water-based drilling muds under conditions of high temperature and pressure, such as those encountered in deep wells.

Sample Formulations

The following examples were used to test the effectiveness of ester derivatives of castor oil fatty acids disclosed herein as lubricants. In the following examples various additives are used including: DUOVIS®, a xanthan gum, and BIOVIS®, a scleroglucan viscosifier, are used as viscosifiers; UNITROL™ is a modified polysaccharide used in filtration; POLYPAC® UL polyanionic cellulose (PAC), a water-soluble polymer designed to control fluid loss; ULTRACAP™, a low-molecular-weight, dry acrylamide copolymer designed to provide cuttings encapsulation and clay dispersion inhibition; ULTRAFREE™, an anti-accretion additive which may be used to eliminate bit balling and enhance rate of penetration (ROP); ULTRAHIB™, a shale inhibitor, EMI-936, a fluid loss control agent; EMI-1001, a shale inhibitor; and EMI-915, an encapsulated shale inhibitor, all of which are commercially available from M-I LLC (Houston, Tex.). EMI-919 is a lubricant used for comparison to one of the novel castor oil fatty acid esters, Ester A, which is an ester produced from the reaction between castor oil and sorbitol and is available from Special Products, Inc., a subsidiary of Champion Technologies, 3130 FM 521, Fresno, Tex. 77245, USA, under the trade name GS-25-62. Referring to Table 1 below, the formulations of the water-based fluids for Samples 1-2 are shown.

TABLE 1
Drilling Fluid Formulations

Sample #

| | 1 | 2 |
|---|---|---|
| Water | 248.0 | 248.0 |
| Sea salt | 10.6 | 10.6 |
| UNITROL ™ | 1.0 | 1.0 |
| BIOVIS ® | 2.0 | 2.0 |
| ULTRACAP ™ | 2.0 | 2.0 |
| ULTRAHIB ™ | 10.5 | 10.5 |
| ULTRAFREE ™ | 10.5 | 10.5 |
| EMI-919 | 10.5 | — |
| Ester A | — | 10.5 |
| Barite | 303.4 | 303.4 |

Fluid rheology was measured at room temperature after aging at 275° F. for 16 hours as shown below in Table 2. The rheological properties of the various mud formulations at 120° F. were determined using a Fann Model 35 Viscometer, available from Fann Instrument Company. Fluid loss and lubricity were also measured.

TABLE 2
Rheology after heat aging at 275° F. for 16 hours

Sample #

| | 1 | 2 |
|---|---|---|
| 600/300 | 100/62 | 107/66 |
| 200/100 | 48/33 | 52/35 |
| 6/3 | 8/6 | 10/8 |
| 10″/10′ | 6/8 | 7/8 |
| PV/YP | 38/24 | 41/25 |
| pH | 7.9 | 8.0 |
| Fluid Loss | 18.0 cc | 10.8 cc |
| Lubricity 5′/10′ | 6.2/6.0 | 7.7/7.5 |

The formulations of the water-based fluids for Samples 3-5 are shown below in Table 3.

TABLE 3
Drilling Fluid Formulations

| | Sample # | | |
|---|---|---|---|
| | 3 | 4 | 5 |
| Water | 248.0 | 248.0 | 248.0 |
| Sea salt | 10.6 | 10.6 | 10.6 |
| UNITROL ™ | 2.0 | 2.0 | 2.0 |
| BIOVIS ® | 1.0 | 1.0 | 1.0 |
| ULTRACAP ™ | 2.0 | 2.0 | 2.0 |
| ULTRAHIB ™ | 10.5 | 10.5 | 10.5 |
| ULTRAFREE ™ | 10.5 | 10.5 | 10.5 |
| EMI-919 | — | 10.5 | — |
| Ester A | — | — | 10.5 |
| Barite | 303.4 | 303.4 | 303.4 |

Fluid rheology was measured after aging at 275° F. as shown below in Table 4. The rheological properties of the various mud formulations at 120° F. were determined using a Fann Model 35 Viscometer, available from Fann Instrument Company. Fluid loss and lubricity were also measured.

TABLE 4
Rheology after heat aging at 275° F., 16 hours.

| | Sample # | | |
|---|---|---|---|
| | 3 | 4 | 5 |
| 600/300 | 96/63 | 100/78 | 115/74 |
| 200/100 | 47/31 | 54/37 | 57/37 |
| 6/3 | 7/5 | 8/5 | 10/7 |
| 10″/10′ | 8/11 | 8/10 | 7/8 |
| PV/YP | 33/30 | 22/56 | 41/33 |
| pH | 8/3 | 7.8 | 8.3 |
| Fluid Loss | 32 cc | 22 cc | 19 cc |

22.5 ppb gel slurries of the lubricants, EMI-919 (Sample 6) and Ester A (Sample 7), in a base fluid (Sample 8) were formed, and their fluid rheology was measured before and after aging at 150° F. for 16 hours as shown in Table 5. The rheological properties of the various slurries at 120° F. were determined using a Fann Model 35 Viscometer, available from Fann Instrument Company. Fluid loss and lubricity were also measured.

TABLE 5
Rheology before and after heat aging

| | Sample # | | | | | |
|---|---|---|---|---|---|---|
| | 6-Before | 7-Before | 8-Before | 6-After | 7-After | 8-After |
| 600/300 | 69/46 | 59/38 | 52/34 | 83/60 | 64/42 | 60/39 |
| 200/100 | 36/25 | 30/20 | 26/18 | 48/34 | 33/22 | 30/20 |
| 6/3 | 9/8 | 7/6 | 7/6 | 13/12 | 8/7 | 7/6 |
| 10″/10′ | 9/27 | 7/23 | 7/22 | 12/31 | 6/23 | 7/23 |
| PV/YP | 23/23 | 23/21 | 18/16 | 23/37 | 22/20 | 21/18 |
| pH | 7.85 | 7.81 | 8.36 | 8.23 | 7.57 | 8.4 |
| Fluid Loss (cc) | 12.2 | 11.8 | 12.6 | 12.8 | 12.2 | 12.8 |
| Lubricity 1% 5′/10′ | 14.8/10.8 | 9.0/7.4 | 32.2/30.1 | — | — | — |
| Lubricity 3% 5′/10′ | 8.2/4.8 | 6.9/5.3 | 32.2/30.1 | 9.6/7.4 | 8.1/7.2 | 35.8/31.5 |

Modified castor oil lubricants (Samples 2, 5, 7) generally performed about the same or better as compared to known lubricant EMI-919 (Samples 1, 4, 6) and showed improved lubricity as compared to a control sample (Sample 8). Mud properties that improved include fluid rheology, lubricity, and fluid loss.

Referring to Table 6 below, the formulations of the water-based fluids for Samples 9-16 are shown. The fluids included various caster oil esters of the embodiments disclosed herein formed from various ratios of alcohol to castor oil: ester B (pentaerythritol:castor oil-3:4); C (pentaerythritol:castor oil-3:12); D (pentaerthyritol:castor oil-3:8); E (sorbitol:castor oil-6:6); and F (sorbitol:castor oil-3:12). The esters were compared to EMI-919 as described above, unmodified crude castor oil, and unmodified refined castor oil.

TABLE 6
Drilling Fluid Formulations

| | Sample # | | | | | | | |
|---|---|---|---|---|---|---|---|---|
| | 9 | 10 | 11 | 12 | 13 | 14 | 15 | 16 |
| Water | 248.0 | 248.0 | 248.0 | 248.0 | 248.0 | 248.0 | 248.0 | 248.0 |
| Sea salt | 10.6 | 10.6 | 10.6 | 10.6 | 10.6 | 10.6 | 10.6 | 10.6 |
| BIOVIS ® | 1.0 | 1.0 | 1.0 | 1.0 | 1.0 | 1.0 | 1.0 | 1.0 |
| UNITROL ™ | 2.0 | 2.0 | 2.0 | 2.0 | 2.0 | 2.0 | 2.0 | 2.0 |
| ULTRAHIB ™ | 10.5 | 10.5 | 10.5 | 10.5 | 10.5 | 10.5 | 10.5 | 10.5 |
| ULTRACAP ™ | 2.0 | 2.0 | 2.0 | 2.0 | 2.0 | 2.0 | 2.0 | 2.0 |
| ULTRAFREE ™ | 10.5 | 10.5 | 10.5 | 10.5 | 10.5 | 10.5 | 10.5 | 10.5 |
| EMI-919 | 10.5 | — | — | — | — | — | — | — |
| Ester B | — | 10.5 | — | — | — | — | — | — |
| Ester C | — | — | 10.5 | — | — | — | — | — |
| Ester D | — | — | — | 10.5 | — | — | — | — |
| Ester E | — | — | — | — | 10.5 | — | — | — |
| Ester F | — | — | — | — | — | 10.5 | — | — |
| Castor oil (crude) | — | — | — | — | — | — | 10.5 | — |
| Castor oil (refined) | — | — | — | — | — | — | — | 10.5 |
| Barite | 303.4 | 303.4 | 303.4 | 303.4 | 303.4 | 303.4 | 303.4 | 303.4 |

Fluid rheology was measured at 120° F. after aging at 275° F. for 16 hours as shown below in Table 6. The Theological properties of the various mud formulations at 120° F. were determined using a Farm Model 35 Viscometer, available from Fann Instrument Company. Fluid loss and lubricity were also measured.

TABLE 6
Rheology at 120° F. after heat aging at 275° F., 16 hours.

| | Sample # | | | | | | | |
|---|---|---|---|---|---|---|---|---|
| | 9 | 10 | 11 | 12 | 13 | 14 | 15 | 16 |
| 600/300 | 100/62 | 114/76 | 98/62 | 101/63 | 107/66 | 102/62 | 95/60 | 98/62 |
| 200/100 | 48/33 | 64/42 | 49/33 | 49/31 | 52/35 | 47/32 | 47/32 | 49/34 |
| 6/3 | 8/6 | 8/5 | 8/6 | 6/4 | 10/8 | 7/5 | 8/5 | 8/5 |
| 10″/10′ | 6/8 | 5/5 | 6/6 | 4/3 | 7/8 | 5/6 | 5/4 | 5/4 |
| PV/YP | 38/24 | 38/38 | 36/26 | 38/25 | 41/25 | 40/22 | 35/25 | 36/26 |
| pH | 7.9 | 7.9 | 8.0 | 7.9 | 8.0 | 8.0 | 7.5 | 7.7 |
| HTHP@275° F. (cc) | 18 | 9 | 12.8 | 25 | 10.8 | 19.6 | 43 | 15 |
| Lubricity 5′/10′ | 6.2/6.0 | 9.7/10 | 8.5/5.7 | 12.8/12.2 | 7.7/7.5 | 10.0/10.0 | 9.7/10.4 | 8.6/8.6 |

Again castor oil modified ester derivatives (Samples 10-13) showed exhibit improved properties, such as rheology, fluid loss, and lubricity, as compared to EMI-919 (Sample 9) and unmodified castor oil (Samples 15-16). In addition, these formulations were also stable up to 275° F.

Advantages of the embodiments disclosed herein may include enhanced Theological properties of the fluids that incorporate the castor oil derivatives described herein. Additionally, the incorporation of esters of castor oil component fatty acids may provide beneficial emollient and lubricating properties. The polar alcohol functional groups in the fatty acids, such as ricinoleic acid, may impart beneficial water solubility characterstics to the ester derivatives of the castor oil fatty acids. Such increases in lubricity may help diminish wear of the drilling equipment. Esters of castor oil also may exhibit low foaming in water and high temperature stabilities, which may provide improvement in extended reach drilling operations. Because castor oil is generally nontoxic, biodegradable, and renewable resource, its derivatives may provide environmentally compatible drilling lubricants. When used in water-based fluids, the lubricants disclosed herein may significantly reduce foaming, which in turn may facilitate adjustment of the viscosity and density.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed:

1. A water based drilling fluid, comprising:
an aqueous fluid;
at least one of a weighting agent and a gelling agent; and
a lubricant comprising at least one ester derivative of at least one fatty acid derived from castor oil.

2. The drilling fluid of claim 1, wherein the at least one fatty acid comprises at least one of ricinoleic acid, linoleic acid, oleic acid, stearic acid, palmitic acid, dihydroxystearic acid, linolenic acid, and eicosanoic acid.

3. The drilling fluid of claim 1, wherein the at least one fatty acid comprises ricinoleic acid.

4. The drilling fluid of claim 1, wherein the ester derivative of the at least one fatty acid is formed from at least one of a mono-, di-, tri-, and polyol.

5. The drilling fluid of claim 4, wherein the ester derivative of at least one fatty acid comprises a polyol based ester, wherein the polyol comprises at least one of sorbitan, pentaerythritol, polyglycerine, and polyglycol.

6. The drilling fluid of claim 5, wherein the ester derivative of the at least one fatty acid comprises at least one of a sorbitan and a pentaerythritol based ester.

7. The drilling fluid of claim 1, wherein the ester derivative is formed from the at least one fatty acid and at least one alcohol in a ratio of at least 1:1.

8. The drilling fluid of claim 6, wherein the ester is formed from the at least one fatty acid and at least one of sorbitan and pentaerythritol in a ratio of at least 2:1.

9. The drilling fluid of claim 1, further comprising:
at least one of a viscosifier, filtration reducer, shale inhibitor, fluid loss control agent, and thinner.

10. A method of treating a wellbore, comprising:
mixing an aqueous fluid, at least one of a weighting agent and a gelling agent, and a lubricant comprising at least one ester derivative of at least one fatty acid derived from castor oil to form a water based wellbore fluid; and
using said water based wellbore fluid during a drilling operation.

11. The method of claim 10, wherein the at least one fatty acid comprises at least one of ricinoleic acid, linoleic acid, oleic acid, stearic acid, palmitic acid, dihydroxystearic acid, lenolenic acid, and eicosanoic acid.

12. The method of claim 11, wherein the at least one fatty acid comprises ricinoleic acid.

13. The method of claim 10, wherein the ester derivative of the at least one fatty acid is formed from at least one of a mono-, di-, tri-, and polyol.

14. The method of claim 13, wherein the ester derivative of at least one fatty acid comprises a polyol based ester, wherein the polyol comprises at least one of sorbitan, pentaerythritol, polyglycerine, and polyglycol.

15. The method of claim 14, wherein the ester derivative of the at least one fatty acid comprises at least one of a sorbitan and a pentaerythritol based ester.

16. The method of claim 10, wherein the ester derivative is formed from the at least one fatty acid and at least one alcohol in a ratio of at least 1:1.

17. The method of claim 15, wherein the ester is formed from the at least one fatty acid and at least one of sorbitan and pentaerythritol in a ratio of at least 2:1.

18. The method of claim 10, wherein the wellbore fluid further comprises:
at least one of a viscosifier, filtration reducer, shale inhibitor, fluid loss control agent, and thinner

19. A wellbore fluid, comprising:
an aqueous fluid;
at least one of a weighting agent and a gelling agent; and
a lubricant comprising at least one ester derivative of ricinoleic acid and at least one of sorbitan and pentaerythitrol.

20. The drilling fluid of claim 19, further comprising:
at least one of a viscosifier, filtration reducer, shale inhibitor, fluid loss control agent, and thinner.
